(19) United States
(12) Patent Application Publication
(10) Pub. No.: US 2026/0142411 A1
(43) Pub. Date: May 21, 2026

(54) Electrical Contact Element and Electrical Connector

(71) Applicant: ROSENBERGER HOCHFREQUENZTECHNIK GMBH & CO. KG, Fridolfing (DE)

(72) Inventors: Markus Oettl, Eiselfing (DE); Sara Schauer, Laufen (DE)

(21) Appl. No.: 19/381,983

(22) Filed: Nov. 6, 2025

(30) Foreign Application Priority Data
Nov. 21, 2024 (EP) 24214402.0

(51) Int. Cl. H01R 13/627

(52) U.S. Cl. CPC H01R 13/6272

(57) ABSTRACT

An electrical contact element which is formed from a re-shaped sheet metal workpiece and is at least substantially sleeve-shaped, having a butt edge which is formed by a first end and a second end of the re-shaped sheet metal workpiece. At least one tab is formed along the butt edge at the first end of the re-shaped sheet metal workpiece. It is provided that the tab covers an end portion of the second end, opposite the first end of the re-shaped sheet metal workpiece along the butt edge, in a lateral direction with respect to a center axis (M) of the contact element, wherein at least one primary bending edge of the tab, around which the tab is bent laterally with its front, free end, runs at least substantially orthogonally to the butt edge.

The invention relates to an electrical contact element which is formed from a re-shaped sheet metal workpiece and is at least substantially sleeve-shaped, having a butt edge formed by a first end and a second end of the re-shaped sheet metal workpiece, as described herein.

The invention also relates to an electrical connector comprising at least one electrical contact element.

Various electrical connectors are known from electrical engineering. Electrical connectors are known to serve to transmit electrical power and/or data signals to corresponding mating connectors. A connector or mating connector may be, in particular, a plug, a printed circuit board connector, a panel connector, a socket, a coupling, or an adapter. The terms “connector” and “mating connector” used in the context of the invention are representative of all variants.

The manufacture of electrical connectors often requires an economical manufacturing process, in particular to enable mass production at low unit costs. Against this background in particular, contact elements are often manufactured as stamped and bent parts, i.e., they are usually stamped out of a sheet metal workpiece or metal sheet and bent into the intended shape (for example, into a sleeve shape).

To attach a contact element to another connector component, for example to a surrounding housing component, contact elements often have detent tabs that are punched out of the sheet metal workpiece and bent accordingly. Punching and bending such a detent tab naturally creates an opening in the contact element, which reduces the mechanical stability of the contact element (in particular, in the case of a sleeve-shaped contact element, this interrupts the stabilizing sleeve-shaped geometry). The opening in the contact element can also impair the electrical properties of the contact element (for example, in the case of an external conductor contact element, its shielding effect may be impaired).

In particular, if the punched-out detent tab is formed in the area of a butt edge between two ends of the sheet metal workpiece re-shaped into a sleeve shape, the mechanical stability of the contact element may be particularly impaired. In this case, the detent tab itself is often mechanically weakened, as it is composed of two halves formed by the respective ends of the sheet metal workpiece.

In view of the known prior art, the object of the present invention is to provide an electrical contact element with optimized mechanical and electrical properties, which is preferably also economical to manufacture in mass production.

A further object of the present invention is to provide an electrical connector with an electrical contact element that has optimized mechanical and electrical properties and that can preferably also be manufactured economically in mass production.

The object is achieved for the electrical contact element with the features disclosed herein. With regard to the electrical connector, the object is also achieved by the features disclosed herein.

The features described below relate to advantageous embodiments and variants of the invention.

The invention relates to an electrical contact element which is formed from a re-shaped sheet metal workpiece or sheet metal element (i.e., from a predominantly flat metal part) and is at least substantially sleeve-shaped. The electrical contact element has a butt edge formed by a first end and a second end of the re-shaped sheet metal workpiece.

The fact that the sheet metal workpiece is at least substantially sleeve-shaped can be understood to mean that the contact element is at least partially substantially completely closed in the circumferential direction or in cross-section. However, one or more slots in the axial and/or circumferential direction may remain in the area of the butt edge. Furthermore, recesses or openings may be provided in the sheet metal workpiece. It should also be mentioned that the ends bent toward each other in the area of the butt edge do not necessarily have to be connected to each other or touch each other. The two ends may also be spaced apart from each other, as long as at least in portions there is an approximately ring-shaped cross-section.

The contact element can be described as at least substantially sleeve-shaped within the meaning of the invention, in particular if the function of a sleeve (e.g., as protection, guidance, or for accommodating further connector or cable components) can be fulfilled, even if there are geometric deviations from an ideal sleeve.

Preferably, the contact element has a geometry that at least resembles a sleeve, i.e., it can, for example, have an elongate, hollow, generally cylindrical or conical shape that serves to accommodate or enclose further connector or cable components.

The electrical contact element may have a round, elliptical, rectangular, polygonal, or other cross-sectional profile.

In this context, a “butt edge” refers in particular to the edge or surface where the two ends of the sheet metal workpiece meet in the re-shaped state. The butt edge is thus only created by re-shaping or joining said ends and is therefore formed by both ends together. This means that each of said ends preferably has its own butt surface at its edge, wherein these edges that meet or are aligned with each other (but do not necessarily have to touch) form the butt edge. The term “butt edge” may also refer to or include the joint or gap between said ends in the context of the present invention.

According to the invention, at least one tab is formed along the butt edge at least at the first end of the re-shaped sheet metal workpiece.

Said tab may be designed to perform any mechanical and/or electrical function for the contact element or within an electrical connector equipped with the contact element. Preferably, the tab is a detent tab with which the contact element can be latched or locked onto or within another connector or cable component (in particular within a connector component surrounding the contact element, such as a contact element carrier or a connector housing, or onto a dielectric inserted into the contact element).

Alternatively or additionally, the tab may also be an electrical contact tab for contacting another electrically conductive connector or cable component or a mating contact element of a mating connector.

According to the invention, the tab is provided to cover an end portion of the second end, opposite the first end of the re-shaped sheet metal workpiece along the butt edge, in a lateral direction with respect to a center axis of the contact element (i.e., the covering preferably occurs in a top view of the contact element directed toward the center axis). At least one primary bending edge of the tab, around which the tab is bent laterally with its front, free end, runs at least substantially orthogonally to the butt edge.

The fact that the course of the primary bending edge of the tab runs at least substantially orthogonally to the butt edge can be understood in particular as a deviation of less than 45° from an orthogonal course, preferably less than 20°, and more preferably less than 5°. It is particularly preferred that the primary bending edge of the tab runs orthogonally to the butt edge.

It is particularly preferred that the front, free end of the tab is bent laterally outwards, i.e., bent away from the center axis. The tab can thus protrude outwards from the outer lateral shell of the contact element. The contact element can thus be accommodated and fixed in another component (e.g., in a contact element carrier, in a dielectric, or in a connector housing) or electrically contact said component (e.g., a counter contact element or a separate outer conductor component).

In principle, however, the tab can also be bent toward the center axis. The tab can thus protrude inward from the inner jacket of the contact element. The contact element can thus, for example, accommodate and fix another component on the inside (e.g., a dielectric, in particular if the contact element is designed as an outer conductor contact element) and/or can make electrical contact with it (e.g., a counter contact element, a separate spring cage for contacting a counter contact element, or an outer conductor of a cable).

The contact element can basically be any contact element (in particular an inner conductor or outer conductor contact element). The contact element can also be a single component of a multi-part contact element.

The tab is described below substantially as a single latching tab arranged on the outside of the electrical contact element and the contact element as an outer conductor contact element, but this should not be understood as limiting the invention.

Due to the fact that the tab formed at the first end of the sheet metal workpiece covers the second end of the sheet metal workpiece at least in portions in the deformed state of the sheet metal workpiece, an opening below the tab or its negative mechanical and electrical effect can be significantly reduced. In particular, the electrical properties of the contact element, for example the shielding effect of an outer conductor contact element, can be improved as a result.

The tab can be designed to be elastic at least in portions, for example in order to be reversibly movable during assembly of the contact element in the connector and/or in order to provide sufficient contact pressure for robust electrical contacting or mechanical centering and/or fixing.

In an advantageous development of the invention, it may therefore be provided in particular that the tab has an elastic spring portion between its free end and the primary bending edge.

The elastic spring portion is preferably elastic in the lateral direction relative to the center axis of the electrical connector or the electrical contact element, so that the free end of the tab can move toward or away from the center axis against an elastic restoring force.

The elastic spring portion of the tab, which preferably forms the foremost portion of the tab, is preferably the functionally relevant part of the tab for its mechanical and/or electrical use in the electrical connector. The elastic spring portion can therefore preferably be used for direct locking and/or contacting with a separate component. Due to its elasticity, the tab can snap in with its front, free end during the assembly of the contact element, for example behind an undercut or in a detent recess of a connector component.

In one embodiment of the invention, the tab may have an attachment portion that runs between the primary bending edge and a base point of the tab connected to a lateral surface of the sheet metal workpiece.

Said attachment portion is preferably a transition area of the tab that connects the elastic spring portion to the base point of the tab. The base point can form the transition between the tab and the further lateral surface or the main body/sheet metal workpiece in the area of the first end. The base point is thus the area from which the tab emerges.

It may be preferable for a main direction of extent of the attachment portion to run at an angle to a main direction of extent of the elastic spring portion, preferably at least substantially orthogonally, and particularly preferably orthogonally. This means, in particular, that a center axis of the tab may run at an angle between the base point and the free end of the tab. The center axis of the tab may preferably be composed of two center axis segments extending at an angle to each other, wherein a center axis segment of the attachment portion may preferably be oriented at least substantially orthogonally to the center axis segment of the spring portion.

According to a development of the invention, it may be provided that the base point of the tab is spaced apart from the butt edge in the circumferential direction.

Preferably, the attachment portion extends, starting from the base point, at least partially in the circumferential direction through the sheet metal workpiece or within the lateral shell of the sleeve-shaped contact element. It may therefore be provided in particular that the attachment portion is at least partially worked out or punched out of the lateral surface of the sheet metal workpiece in a state where the sheet metal workpiece has not yet been bent.

The geometry of the tab can basically be arbitrary within the scope of the invention. In particular, the length and width of the tab can be designed, in view of the intended use, in such a way that a good technical compromise is achieved between sufficient rigidity of the tab for secure fixing (for example, in a detent recess of an adjacent connector component) or for secure electrical contacting (for example, of a further connector component or a mating contact element), and also sufficient flexibility to prevent scraping or other damage during the assembly process and also to reduce the assembly force required.

It may be provided that the tab extends completely over the entire length of the butt edge. However, according to a preferred development of the invention, it may be provided in particular that the tab is formed only along a portion of the butt edge.

At this point, it should be mentioned that it may also be provided that, in principle, several tabs are formed along the butt edge-if necessary, also starting from both ends, i.e., alternately from the first end and the second end of the sheet metal workpiece. For the sake of clarity, the invention is described below with only a single tab, which should not be understood as limiting.

In a development of the invention, it may be provided that at least one secondary bending edge is formed in the attachment portion, around which the attachment portion is bent laterally, preferably away from the center axis of the contact element, but also towards the center axis if required for the application.

It is particularly preferred that the tab in the attachment portion has a pair of bending edges consisting of two spaced-apart secondary bending edges, around which the attachment portion is bent laterally in opposite directions, so that (viewed in cross-section) the tab preferably has at least a substantially S-shaped bending profile in the attachment portion. In particular, it may be provided that the tab is first bent from a tangential direction of extent into a lateral direction of extent and then back again from the lateral direction of extent into the tangential direction of extent by using the two secondary bending edges.

In particular, the S-shaped bend can serve to offset the tab in a defined manner relative to the lateral surface of the sheet metal workpiece or the contact element. The S-shaped bending path allows the tab or at least the attachment portion of the tab to rest tangentially on the lateral surface of the electrical contact element (in particular on the covered portion of the second end) on the inside or outside, for example.

In a development of the invention, it may be provided that the secondary bending edges of the pair of bending edges run at least substantially parallel to each other.

The secondary bending edges of the pair of bending edges may also preferably run at least substantially parallel to the butt edge.

The secondary bending edges of the pair of bending edges may also preferably run at least substantially orthogonally to the primary bending edge.

In principle, however, the primary and secondary bending edges may be arranged at any angle to each other (less preferred). For example, it may also be provided that the primary bending edge and the at least one secondary bending edge run at least substantially parallel to each other.

In an advantageous development of the invention, it may be provided that the tab runs at least substantially in an L-shape in a top view.

Preferably, a first end of the L-shaped tab can thus represent the front, free end of the tab (i.e., in particular, the elastic spring portion) and the second end of the L-shaped tab can form the base point via which the tab is connected to the sheet metal workpiece.

In principle, however, any course of the tab may be provided, starting from the base point to the free end, for example, a Z-shaped, S-shaped, zigzag-shaped, or other course.

In a development of the invention, it may be provided that the second end of the re-shaped sheet metal workpiece runs straight along the butt edge so that the tab covers a lateral shell portion extending from the second end.

A straight course of the second end of the re-shaped sheet metal workpiece is understood in particular to mean a course of the second end without significant projections and/or recesses in the circumferential direction. The end face of the second end is thus preferably completely flat.

In an advantageous development of the invention, however, it may also be provided that the second end of the re-shaped sheet metal workpiece has a laterally protruding lug portion which extends at least partially under the tab.

The second end and the first end can thus, for example, engage with each other at least in portions, thereby forming a structure similar to interlocking/intermeshing or even a puzzle-like structure. If necessary, it may also be provided that the two ends interlock to provide a form fit in the circumferential direction (e.g., a dovetail joint), thereby preventing the re-shaped, sleeve-shaped contact element from springing back.

In an advantageous development of the invention, it may be provided that the tab with the attachment portion rests at least partially directly on the covered end portion of the second end of the re-shaped sheet metal workpiece.

The attachment portion can thus serve in particular advantageously to support the elastic spring portion and better support the mechanical stability of the contact element as a whole.

In an advantageous development of the invention, it may be provided in particular that the attachment portion is fastened to the end portion of the second end of the re-shaped sheet metal workpiece.

Said fastening can in principle be realized in any manner. However, an integrally bonded fastening (e.g., a welded, soldered, or adhesive connection) and/or a form-fitting fastening (e.g., a latching, locking, or clinch connection) is preferably provided.

It should be mentioned at this point that the attachment portion may alternatively also be spaced apart from the lateral surface of the contact element or the sheet metal workpiece, for example in order to increase the elasticity of the tab.

In a development of the invention, it may be provided that the first end and the second end of the re-shaped sheet metal workpiece are connected or fastened to each other along the butt edge, at least in portions.

It is not absolutely necessary to fasten the first end to the second end, but it can be advantageous in order to avoid unwanted springing of the sleeve-shaped contact element at the butt edge and to increase mechanical stability.

Insofar as the two ends are fastened or connected to each other, this can generally be done using any fastening technique, wherein an integrally bonded fastening technique (e.g., a welded, soldered, or adhesive connection) and/or a form-fitting fastening technique (e.g., a latching, locking or clinch connection) may be preferred.

According to a development of the invention, it may be provided that the front, free end of the tab is aligned in the direction of a cable-side end of the contact element.

The fact that the front, free end of the tab is aligned in the direction of the cable-side end of the contact element has the advantage that, on the one hand, the contact element can be mounted starting from the cable-side end of a connector (which is generally preferred) and, on the other hand, a particularly secure cable pull-up support can be provided. In principle, however, the front, free end of the tab can be aligned in any direction.

In an advantageous development of the invention, the front, free end of the tab may have a chamfer.

This can simplify the joining or assembly of the electrical contact element into a surrounding component or the insertion of a further component into the contact element.

In particular, to further support the assembly of the contact element within the connector, a mechanical coding (e.g., one or more projections) may optionally be formed at least one end of the contact element, which corresponds to a suitable counter-coding (e.g., a recess or an opening) of a counterpart of the connector. This ensures that the contact element can only be mounted in the electrical connector in the correct orientation or phase position.

The invention also relates to an electrical connector comprising at least one electrical contact element according to the above and following descriptions.

It may be provided that the electrical connector has a contact element carrier and/or a connector housing for receiving the at least one contact element.

The contact element is preferably mounted inside the connector housing and/or contact element carrier. The tab can lock or latch the contact element inside the connector (e.g., inside the connector housing or contact element carrier).

It may be provided that the electrical connector has a dielectric mounted within the contact element. The tab can latch or lock the dielectric within the contact element.

As already mentioned above, the tab of the contact element can also be used for electrical contacting within the connector (e.g., for electrical contacting of an electrically conductive outer housing) or for contacting by a mating contact element of a corresponding mating connector.

The contact element may be an outer conductor contact element, an inner conductor contact element, or any other contact element (or part of a multi-part contact element) of the connector. Preferably, the contact element is designed as an outer conductor contact element.

The electrical connector is not limited to a specific connector standard or a specific application. The electrical contact element may be advantageously suitable for a straight or angled connector. The invention may be advantageously used, among other things, for cable connectors, printed circuit board connectors, housing connectors, or adapter plugs. Due to the optimized electrical properties of the contact element, the invention is particularly suitable for connectors used in high-frequency technology (e.g., coaxial connectors), although this is not to be understood as a limitation.

The invention also relates to a method for producing an electrical contact element, comprising at least the following method steps (which do not necessarily have to be carried out in the order specified):
providing a sheet metal workpiece;
re-shaping the sheet metal workpiece into an at least substantially sleeve-shaped geometry so that a common butt edge is formed by a first end and a second end of the sheet metal workpiece;
forming at least one tab at the first end of the sheet metal workpiece along the butt edge so that the tab covers an end portion of the second end opposite the first end of the re-shaped sheet metal workpiece along the butt edge in a lateral direction relative to a center axis of the contact element;
bending a front end of the tab in a lateral direction around at least one primary bending edge that runs at least substantially orthogonal to the butt edge.

Features described in conjunction with one of the objects of the invention, namely given by the electrical contact element according to the invention, the electrical connector according to the invention, and the method according to the invention for manufacturing the electrical contact element, can also be advantageously implemented for the other objects of the invention. Similarly, advantages mentioned in conjunction with one of the objects of the invention can also be understood as relating to the other objects of the invention.

It should also be noted that terms such as “comprising,” “having,” or “with” do not exclude other features or steps. Furthermore, terms such as “one” or “the” which refer to a singular number of steps or features, do not exclude a plurality of features or steps—and vice versa.

It should be noted that terms such as “first” or “second” etc. are used primarily for reasons of distinguishability between respective device or method features and are not necessarily intended to imply that features are mutually dependent on or related to each other.

Furthermore, it should be emphasized that the values and parameters described herein include deviations or fluctuations of ±10% or less, preferably ±5% or less, more preferably ±1% or less, and very particularly preferably ±0.1% or less of the respective specified value or parameter, provided that these deviations are not excluded in the practical implementation of the invention. The specification of ranges by start and end values also includes all values and fractions included in the respective specified range, in particular the start and end values and a respective mean value.

Exemplary embodiments of the invention are described in more detail below with reference to the drawings.

The figures show preferred exemplary embodiments in which individual features of the present invention are shown in combination with each other. Features of an exemplary embodiment can also be implemented separately from the other features of the same exemplary embodiment and can therefore be easily combined by a person skilled in the art to form further useful combinations and sub-combinations with features of other exemplary embodiments.

In the figures, elements with the same function are provided with the same reference signs.

Schematically shown are:

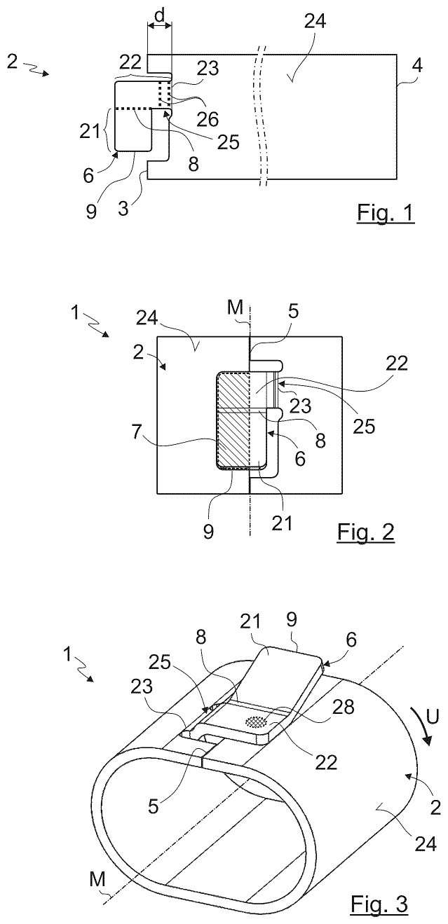

FIG. 1 a sheet metal workpiece for forming a sleeve-shaped contact element according to a first exemplary embodiment of the invention, in a state that has not yet been re-shaped;

FIG. 2 a top view of the sleeve-shaped contact element of FIG. 1, in the re-shaped state of the sheet metal workpiece;

FIG. 3 a perspective view of the sleeve-shaped contact element of FIG. 1, in the re-shaped state of the sheet metal workpiece;

FIG. 4 a perspective view of a sleeve-shaped contact element according to a second exemplary embodiment, in the re-shaped state of the sheet metal workpiece;

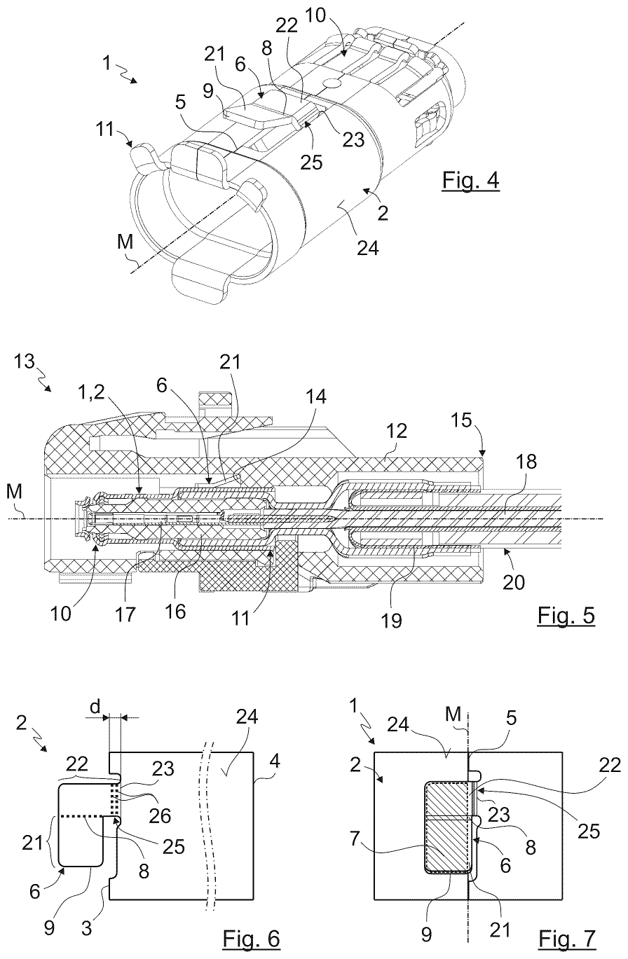

FIG. 5 an electrical connector according to an exemplary embodiment, with the electrical contact element according to FIG. 4 in a longitudinal section;

FIG. 6 a sheet metal workpiece for forming a sleeve-shaped contact element according to a third exemplary embodiment of the invention, in an as yet non-re-shaped state;

FIG. 7 a top view of the sleeve-shaped contact element of FIG. 6, in the re-shaped state of the sheet metal workpiece;

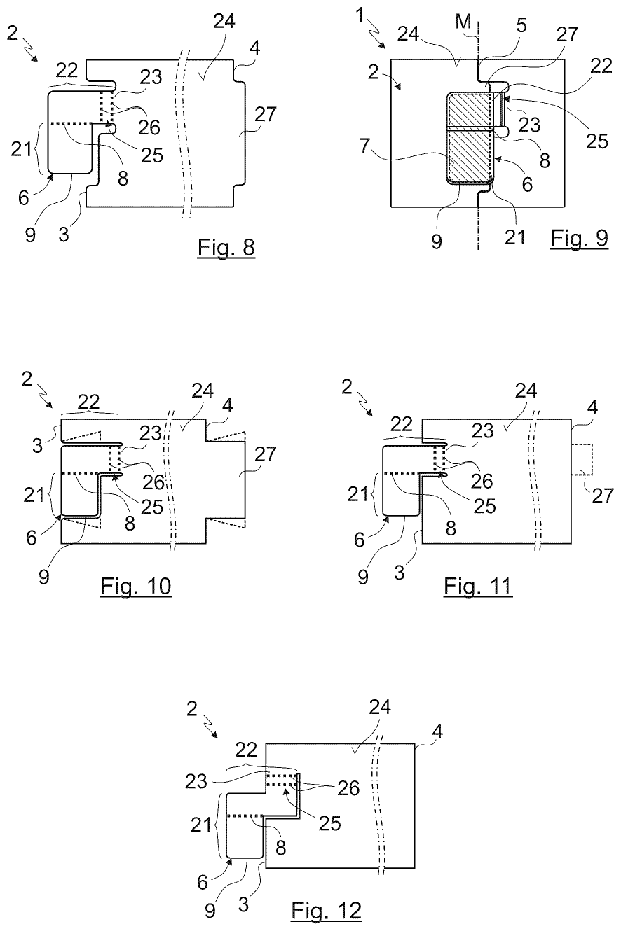

FIG. 8 a sheet metal workpiece for forming a sleeve-shaped contact element according to a fourth exemplary embodiment of the invention, in an as yet non-re-shaped state;

FIG. 9 a top view of the sleeve-shaped contact element of FIG. 8, in the re-shaped state of the sheet metal workpiece;

FIG. 10 a sheet metal workpiece for forming a sleeve-shaped contact element according to a fifth exemplary embodiment of the invention, in an as yet non-re-shaped state;

FIG. 11 a sheet metal workpiece for forming a sleeve-shaped contact element according to a sixth exemplary embodiment of the invention, in an as yet non-re-shaped state; and

FIG. 12 a sheet metal workpiece for forming a sleeve-shaped contact element according to a seventh exemplary embodiment of the invention, in an as yet non-re-shaped state.

FIGS. 1 to 3 show an example of a first exemplary embodiment of an electrical contact element 1 according to the invention. The electrical contact element 1 is formed from a re-shaped sheet metal workpiece 2 and is at least substantially sleeve-shaped. FIG. 1 shows the sheet metal workpiece in its as yet non-re-shaped state and FIGS. 2 and 3 show it in a re-shaped state. FIG. 2 shows a top view in the direction of the center axis M of the contact element 1 and FIG. 3 shows a perspective view.

In the context of the invention, the sheet metal workpiece 2 is formed in such a way that a common butt edge 5 (see FIGS. 2 and 3) is formed by a first end 3 and a second end 4 of the sheet metal workpiece 2 (see FIG. 1 in each case). A tab 6 is formed along said butt edge 5 at the first end 3 of the re-shaped sheet metal workpiece 2 (in principle, several tabs 6 may also be provided, if necessary also tabs extending from the second end 4 of the sheet metal workpiece 2). For the sake of clarity, the figures show only a single tab 6 extending along a portion of the butt edge 5, but this should not be understood as limiting the invention.

It is provided that the tab 6 has an end portion 7 (see dashed and hatched lines in FIG. 2) of the second end 4 opposite the first end 3 of the re-shaped sheet metal workpiece 2 along the butt edge 5 in a lateral direction relative to the center axis M of the contact element 1 (i.e., in a top view, as shown in FIG. 2).

Because the tab 6 covers at least part of the second end 4 of the sheet metal workpiece 2, the opening below the tab 6 can be advantageously closed or filled by the end portion 7 of the second end 4 for electrical and mechanical optimization of the contact element 1. The contact element 1 is therefore able to offer improved electrical and mechanical properties compared to the prior art.

The tab 6 has at least one primary bending edge 8 around which the tab 6 is bent laterally with its front, free end 9. In the exemplary embodiment, the primary bending edge 8 runs orthogonally to the butt edge 5.

In the exemplary embodiments, the tab 6 is bent outward with its front, free end 9, i.e., bent away from the center axis M of the contact element 1. However, depending on the application, it may also be provided that the tab 6 is bent inward and thus protrudes into the sleeve-shaped contact element 1.

A second exemplary embodiment of the contact element 1, similar to the first exemplary embodiment, is shown in FIG. 4. The contact element 1 corresponds at least substantially to the first exemplary embodiment in the area of the tab 6, but apart from that it is more complex in terms of geometry and function. It should be noted at this point that the contact elements 1 shown in FIGS. 1 to 3 and 6 to 12 are only examples and are intended to illustrate the basic principle of the invention. The contact element 1 according to FIG. 4 has a plug-in area 10 designed as a spring basket for a mating contact element of a mating connector (not shown), as well as a cable-side base area 11 for fastening in a contact element carrier or a connector housing 12. A specific installation situation of the contact element 1 of FIG. 4 in a connector housing 12 of an electrical connector 13 according to an exemplary embodiment of the invention is shown by way of example in FIG. 5 in a longitudinal section.

The electrical contact element 1, which in the exemplary embodiments is, by way of example, an outer conductor contact element, is fixed in the connector housing 12 in FIG. 5 by means of the tab 6. In the present example, the tab 6 serves as a detent tab and is locked behind an undercut 14 in the connector housing 12. Assembly can be advantageously carried out starting from the cable-side end 15 of the connector 13. The front, free end 9 of the tab 6 is aligned in this case in the direction of the cable-side end 15 of the contact element 1 or connector 13 and is able to spring in during assembly and spring back out again in the final assembly position shown in FIG. 5. To facilitate insertion of the contact element 1 into the connector housing 12, the tab 6 may optionally have a chamfer at its front, free end 9. Optionally, mechanical coding, etc., may also be provided for the contact element 1 in order to insert the contact element 1 into the connector housing 12 only in a predetermined orientation and alignment.

As an example, FIG. 5 shows a dielectric 16 within the contact element 1 according to the invention and, in turn, an inner conductor contact element 17 within the dielectric 16. The inner conductor contact element 17 and the contact element 1 according to the invention, which is designed as an outer conductor contact element, are connected to the corresponding inner conductor 18 and outer conductor 19 of the cable 20 at the cable-side end 15 of the connector 13. The specific installation situation is, of course, only an example and should not be understood as limiting the invention, since the invention can in principle be suitable for any type of connector (for example, also for angled connectors and non-coaxial connectors). In particular, the contact element 1 according to the invention may also be an inner conductor contact element or another contact element, for example a support sleeve or another electrically conductive component required within the connector 13.

The tab 6 has an elastic spring portion 21 between its front, free end 9 and the primary bending edge 8. This can preferably serve for latching and/or electrical contacting with a separate component, such as the aforementioned connector housing 12 of the electrical connector 13. Furthermore, the tab 6 has an attachment portion 22 which runs between the primary bending edge 8 and a base point 23 of the tab 6 connected to the sheet metal workpiece 2. In the exemplary embodiments shown in FIGS. 1 to 11, said base point 23 is spaced apart from the butt edge 5 in the circumferential direction U (see FIG. 3), so that the attachment portion 22, starting from the first end 3, at least partially in the circumferential direction U within the lateral shell of the sleeve-shaped contact element 1. For this purpose, the attachment portion 22 was preferably at least partially worked out or punched out of the lateral surface 24 of the sheet metal workpiece 2, which had not yet been bent, during manufacture.

The position of the base point 23 or its distance d from the butt edge 5 (see in particular FIG. 1) can be used to specify the opening formed at the first end 3. By way of example, the exemplary embodiment of a further electrical contact element 1 according to the present invention shown in FIGS. 6 and 7 is intended to illustrate an alternative position of the base point 23 relative to the butt edge 5 (see the changed distance d from the butt edge 5 in FIG. 6). It should be noted that a certain opening or a certain width of the opening may generally be required in order to provide sufficient space for the S-shaped bend of the tab 6 described below. It should also be mentioned that if the distance d between the base point 23 and the butt edge 5 is reduced, the tab 6 is positioned increasingly off-center from the butt edge 5 in the circumferential direction U when assembled (see FIGS. 2 and 7 together). Depending on the application, this offset may not be a problem and can be taken into account by a person skilled in the art when designing the contact element 1.

A pair of bending edges 25 consisting of two secondary bending edges 26 spaced apart from each other may be formed in the attachment portion 22 of the tab 6 (see FIG. 1 in particular), around which the attachment portion 22 is bent laterally in opposite directions, as can be seen particularly well in FIG. 3. In this way, a preferably at least substantially S-shaped bending path can result, whereby the tab 6 with its attachment portion 22 can rest tangentially on the lateral surface 24 of the contact element 1. In the exemplary embodiments shown in FIGS. 1 to 11, the secondary bending edges 26 of the pair of bending edges 25 run parallel to the butt edge 5 and also orthogonally to the primary bending edge 8. The tab 6 can thus have at least a substantially L-shaped profile when viewed from above.

At this point, however, it should be mentioned that an L-shaped configuration of the tab 6 and, in particular, the aforementioned alignment of the bending edges 8, 26 relative to each other is not absolutely necessary. Reference is made, for example, to the exemplary embodiment shown in FIG. 12, in which the parallel alignment of all bending edges 8, 26 results in a z-shaped or zigzag-shaped configuration of the tab 6 in a top view. In principle, there are many other possibilities for implementing the tab 6 according to the invention.

It may be provided that the second end 4 of the re-shaped sheet metal workpiece 2 runs straight along the butt edge 5, so that the tab 6 covers a lateral shell or end portion 7 extending from the second end 4, as already described in FIG. 2. In particular, it may be provided that the second end 4 has no projections or recesses in the circumferential direction, as can be clearly seen in particular in the exemplary embodiment shown in FIGS. 6 and 7.

In principle, however, it is also possible for the second end 4 of the re-shaped sheet metal workpiece 2 to have a laterally protruding lug portion 27 which, in the re-shaped state of the sheet metal workpiece 2, extends at least partially under the tab 6. In this way, the opening below the tab 6 can be closed even more optimally if necessary. The tab 6 can thus cover the laterally protruding lug portion 27 of the second end 4, as shown, for example, in the exemplary embodiment of FIGS. 8 and 9.

As can be seen in particular from FIG. 3, the tab 6 with the attachment portion 22 can rest at least partially directly on the covered end portion 7 of the second end 4 of the re-shaped sheet metal workpiece 2. The attachment portion 22 can also be optionally fastened to the covered end portion 7 of the second end 4 of the re-shaped sheet metal workpiece 2, in particular in an integrally bonded and/or a form-fitting manner. In this way, the mechanical stability of the contact element 1 can be further improved. An example of a solder point 28 of the tab 6 is indicated by a dashed line in FIG. 3. Optionally, it may also be provided that the first end 3 and the second end 4 of the re-shaped sheet metal workpiece 2 are connected to each other along the butt edge 5, at least in portions, in an integrally bonded and/or form-fitting manner.

By way of example, FIGS. 10 and 11 show two variants of advantageous tabs 6, wherein in FIG. 10, the distance between the base point 23 and the first end 3 or the butt edge 5 is dimensioned such that the entire tab 6 is located within the sheet metal workpiece 2 when the sheet metal workpiece 2 is in the non-re-shaped state. In contrast, according to the exemplary embodiment shown in FIG. 11, the elastic spring portion 21 of the tab 6 protrudes completely from the first end 3 of the sheet metal workpiece 2. In the case of FIG. 10, the opening formed under the tab 6 in the formed or finished state of the contact element 1 can in turn be closed by means of a correspondingly suitable, laterally protruding lug portion 27 of the second end 4, whereas in the case of the exemplary embodiment shown in FIG. 11, the second end 4 can run in a purely straight line. However, in the exemplary embodiment shown in FIG. 11, a lug portion 27 (shown as a dashed line) may also be provided as an option in order to close the opening of the tab 6 in the area of the attachment portion 22.

FIG. 10 also illustrates, by way of example, that an undercut may optionally be provided between the first end 3 and the second end 4 of the sheet metal workpiece 2, so that inserting the second end 4 into the opening below the tab 6 simultaneously provides improved mechanical fixation of the first end 3 to the second end 4, thereby preventing the sleeve-shaped contact element 1 from springing up in the area of the butt edge 5. For example, the lug portion in FIG. 10 can be conically shaped for this purpose (shown as dashed lines), so that a dovetail connection with a corresponding course of the other or first end 3 (also indicated as dashed lines) can be provided.

As already mentioned, the invention offers many different possibilities for the geometric design of the contact element 1, its tab 6, and for the covering of the second end 4 of the sheet metal workpiece 2 in order to at least partially close the opening below the tab 6. The above examples are therefore not exhaustive or limiting, but are only to be understood as examples of the invention.

1. An electrical contact element which is formed from a re-shaped sheet-metal workpiece and which is at least substantially sleeve-shaped,
the electrical contact element comprising:
a butt edge formed by a first end of the re-shaped sheet-metal workpiece and a second end of the re-shaped sheet-metal workpiece,
wherein an at least one tab is formed along the butt edge at the first end of the re-shaped sheet-metal workpiece,
wherein the tab covers an end portion of the second end of the re-shaped sheet-metal workpiece, opposite the first end of the re-shaped sheet-metal workpiece along the butt edge, in a lateral direction with respect to a center axis (M) of the contact element, and
wherein an at least one primary bending edge of the tab, around which the tab is bent laterally with a front end of the tab, extends at least substantially orthogonally to the butt edge.

2. The electrical contact element of claim 1, wherein the tab includes (i) an elastic spring portion between the front end of the tab and the primary bending edge of the tab, (ii) an attachment portion which runs between the primary bending edge of the tab and (iii) a base point which is connected to a lateral surface of the sheet-metal workpiece.

3. The electrical contact element of claim 2, wherein the base point is spaced apart from the butt edge in a circumferential direction (U).

4. The electrical contact element of claims 1, wherein the tab is formed only along a portion of the butt edge.

5. The electrical contact element of claim 2,
wherein the attachment portion includes two secondary bending edges spaced apart from each other, and
wherein the attachment portion is bent laterally around each of the two secondary bending edges in opposite directions.

6. The electrical contact element of claim 5, wherein each of the two secondary bending edges runs at least substantially parallel to the butt edge.

7. The electrical contact element of claim 1, wherein the tab is at least substantially L-shaped in a top view.

8. The electrical contact element of claim 1, wherein the second end of the re-shaped sheet-metal workpiece extends in a straight line along the butt edge.

9. The electrical contact element of claims 1, wherein the second end of the re-shaped sheet-metal workpiece has a laterally protruding lug portion that extends at least partially under the tab.

10. The electrical contact element of claim 2, wherein the attachment portion of the tab rests at least partially directly on the end portion of the second end of the re-shaped sheet-metal workpiece.

11. The electrical contact element of claim 10, wherein the attachment portion is fastened to the end portion of the second end of the re-shaped sheet-metal workpiece.

12. The electrical contact element of claim 1, wherein the first end of the re-shaped sheet-metal workpiece and the second end of the re-shaped sheet-metal workpiece are connected to each other along the butt edge, at least in portions, in at least one of (i) an integrally bonded manner, and (ii) a form-fitting manner.

13. The electrical contact element of claim 1, wherein the front end of the tab is aligned in a direction of a cable-side end of the contact element.

14. The electrical contact element of claim 1, wherein the front end of the tab has a chamfer.

15. An electrical connector comprising:
an at least one electrical contact element which is formed from a re-shaped sheet-metal workpiece and which is at least substantially sleeve-shaped,
the at least one electrical contact element including a butt edge formed by a first end of the re-shaped sheet-metal workpiece and a second end of the re-shaped sheet-metal workpiece,
wherein an at least one tab is formed along the butt edge at the first end of the re-shaped sheet-metal workpiece,
wherein the tab covers an end portion of the second end of the re-shaped sheet-metal workpiece, opposite the first end of the re-shaped sheet-metal workpiece along the butt edge, in a lateral direction with respect to a center axis (M) of the contact element, and
wherein an at least one primary bending edge of the tab, around which the tab is bent laterally with a front end of the tab, extends at least substantially orthogonally to the butt edge; and
at least one of (i) a contact element carrier for accommodating the at least one contact element and (ii) a connector housing for accommodating the at least one contact element.

16. The electrical connector of claim 15, wherein the tab of the electrical contact element includes (i) an elastic spring portion between the front end of the tab and the primary bending edge of the tab, (ii) an attachment portion which runs between the primary bending edge of the tab and a base point of the tab, and (iii) a base point which is connected to a lateral surface of the sheet-metal workpiece.

17. The electrical connector of claim 16, wherein the base point of the electrical contact element is spaced apart from the butt edge of the electrical contact element in a circumferential direction (U).

18. The electrical contact element of claim 2, wherein the primary bending edge of the tab enables at least one of (i) latching with a separate component, and (ii) contacting with a separate component.

19. The electrical contact element of claim 5, wherein the attachment portion forms a substantially S-shaped bending path.

20. The electrical contact element of claim 11, wherein the attachment portion is fastened to the end portion of the second end of the re-shaped sheet-metal workpiece in at least one of (i) an integrally bonded manner, and (ii) a form-fitting manner.
